(19) United States
(12) Patent Application Publication
(10) Pub. No.: US 2013/0002100 A1
(43) Pub. Date: Jan. 3, 2013

(54) UNDER-SINK RECEPTACLE

(76) Inventors: Zahir Al Badri, Mississauga (CA); Aaron Varolin, Toronto (CA)

(21) Appl. No.: 13/435,490

(22) Filed: Mar. 30, 2012

Related U.S. Application Data
(60) Provisional application No. 61/470,089, filed on Mar. 31, 2011.

(51) Int. Cl. B65F 1/16; A47B 81/00

(52) U.S. Cl. 312/212

(57) ABSTRACT

Apparatus for use in a cabinet is disclosed. The cabinet has a front carrying a door. The apparatus comprises a shuttle that mounts to the cabinet. A bin, having an upper rim and an axis, moves with the shuttle, when said door is open, between a storage position inside the cabinet and an access position outside the cabinet. When the bin is in the storage position, the axis is parallel to the front and adjacent that part of rim that is furthest from the front. The lid has a closed position associated with the storage position whereat the lid occludes the bin and an open position associated with the access position whereat the lid projects upwardly from the axis to permit egress to the bin. The mechanism causes the lid to move between the closed and open positions as the bin is moved between the storage and access positions.

### RELATED APPLICATION

This application claims the benefit of U.S. Provisional Patent Application Ser. No. 61/470,089, filed on Mar. 31, 2011, the disclosure of which is entirely incorporated herein by reference.

### FIELD OF THE INVENTION

The invention relates to the field of kitchen design.

### BACKGROUND OF THE INVENTION

It is commonplace in North American kitchens for the area under the sink to be used for storage. It is also commonplace for kitchen waste to be collected in a receiver housed beneath the sink. One known arrangement is a wire frame, mounted interiorly on one of the doors of the sink cabinet, that is adapted to suspend plastic bags and has a plastic hinged lid. Notwithstanding that bags in this arrangement can burst and become dislodged when loaded, this arrangement remains very popular.

### SUMMARY OF THE INVENTION

Apparatus for use in a base cabinet forms one aspect of the invention. The cabinet is of the type having a planar front face in receipt of one or more doors, the one or more doors defining a door closure. This apparatus comprises: a shuttle assembly mounted in use to the cabinet; a bin mounted to the shuttle assembly for horizontal movement in use, at least when said one or more doors are open, between a storage position inside said cabinet and an access position outside said cabinet, the bin having an upper rim and an axis, the axis, when the bin is in the storage position, being parallel to the front face and adjacent that part of the rim that is furthest from the front face; a lid having a closed position, associated with the storage position of the bin and whereat the lid occludes the bin, and an open position, associated with the access position of the bin and whereat the lid projects upwardly from the axis to permit egress to the bin; and a mechanism adapted to cause the lid to move between the closed position and the open position as the bin is moved between the storage position and the access position.

In a preferred embodiment of the invention:
the bin is relatively shallow and the storage position is adjacent the front face to permit use of the apparatus in a sink cabinet
the apparatus is adapted such that, when the apparatus is in use with a sink cabinet, the bin is in the storage position and the cabinet doors are closed, the bin substantially fully occupies the space (i) between the sink and drain and the front face; and (ii) behind one of the doors
the apparatus further comprises an automation system adapted to drive the bin between the storage and access positions and including: a motor; a rack operatively fixedly mounted to one of the shuttle assembly and the bin; a pinion in mesh with the rack, operatively fixedly mounted to the other of the track and the bin and coupled to the motor; a switch which, if actuated when the bin is in the access position, drives the bin to the storage position and which, if actuated when the bin is in the storage position, drives the bin to the access position
the shuttle assembly includes: a fixed part that is mounted in use to the box; and a movable part that supports the bin and is mounted to the fixed part for sliding movement
the fixed part comprises a pair of tracks and the movable part comprises a platform
the mechanism comprises: a hinged connection between the lid and the bin, to permit pivotable movement of the lid about the axis; and a fixed-length, flexible link connected at one end to the fixed part and at the other end to the lid
the lid includes a portion which, when the lid is closed, cantilevers beyond the axis;
the link includes: a pair of link parts pivotably connected to one another, the free ends of these link parts defining the ends of the flexible link; and a portion, adjacent the junction of the link parts, that, as the bin moves from the storage position to the access position, bears downwardly upon the cantilevered portion of the lid to drive the lid towards the open position
the link parts each consist of a pair of arms, spaced-apart in the direction of the axis
the portion consists of a cross-bar rigidly connecting one of the arm pairs
the apparatus is adapted to restrain the lid against movement beyond the open position.
the apparatus further comprises a transmitter and a receiver
the transmitter is: packaged with the switch; adapted to be mounted on the door closure interior; adapted to produce wireless signals in response to the switch; contained in a housing having a battery receiver; and adapted to be powered by battery power from said receiver.
the receiver is adapted to actuate the motor in response to the wireless signals.

Advantages of the invention will become apparent to persons of ordinary skill in the art upon review of the appended claims and upon review of the following detailed description and the accompanying drawings, the latter being described briefly hereinafter.

### BRIEF DESCRIPTION OF THE DRAWINGS

FIG. 1 is a is a perspective view showing a base cabinet;

FIG. 2 is a view of apparatus according to the preferred embodiment of the invention;

FIG. 3 is a bottom view of the structure of FIG. 2;

FIG. 4 is a perspective view of the apparatus of FIG. 2 in use with the apparatus of FIG. 1, with the bin shown in the storage position and the cabinet door open;

FIG. 5 is a side view of the structure of the FIG. 2;

FIG. 6 is a rear, side perspective view of the structure of FIG. 2;

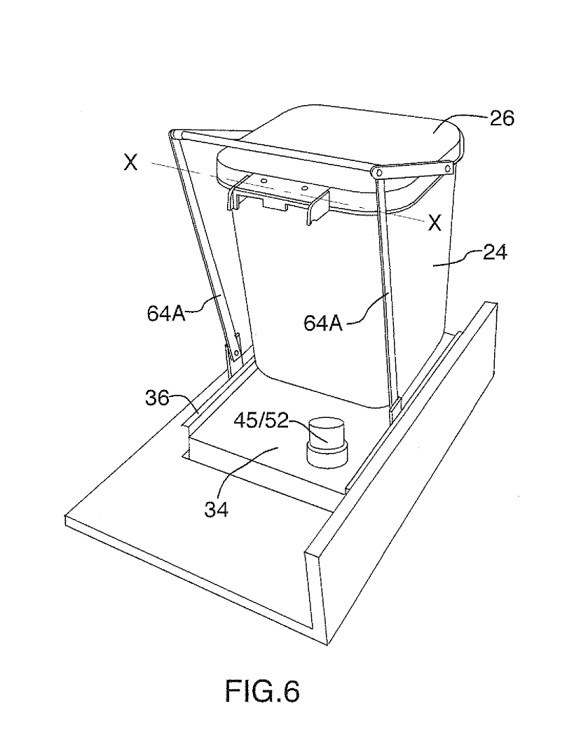

FIG. 7 is a view similar to FIG. 4, with the bin shown at a position intermediate the storage and the access position;

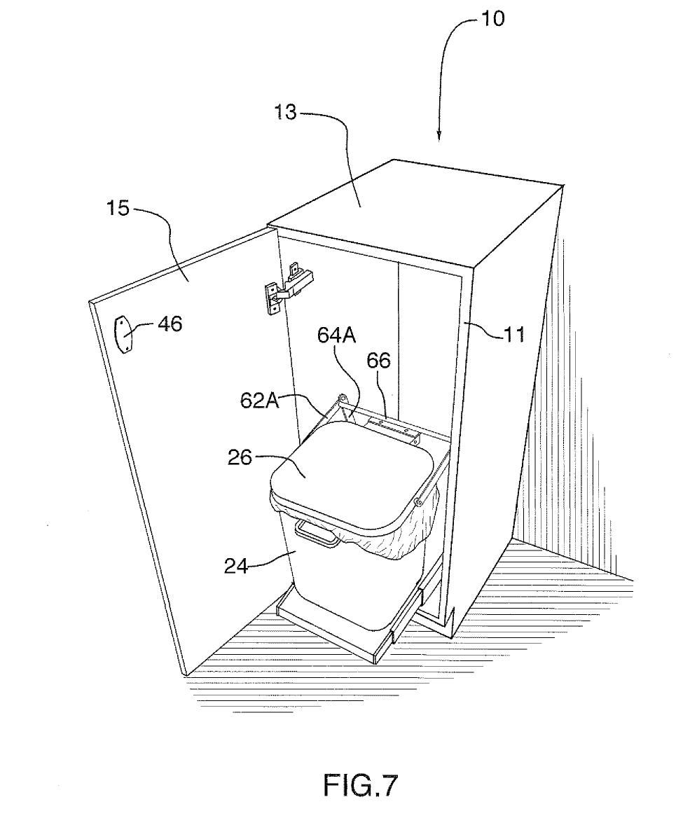

FIG. 8 is a side view of the structure of FIG. 2, with the bin shown at the position of FIG. 7;

FIG. 9 is a view similar to FIG. 7, with the bin shown at a position intermediate the position shown in FIG. 7 and the access position;

FIG. 10 is a side view of the structure of FIG. 2, with the bin shown as it would appear in the access position;

FIG. 11 is an enlarged partial view of the structure of FIG. 10;

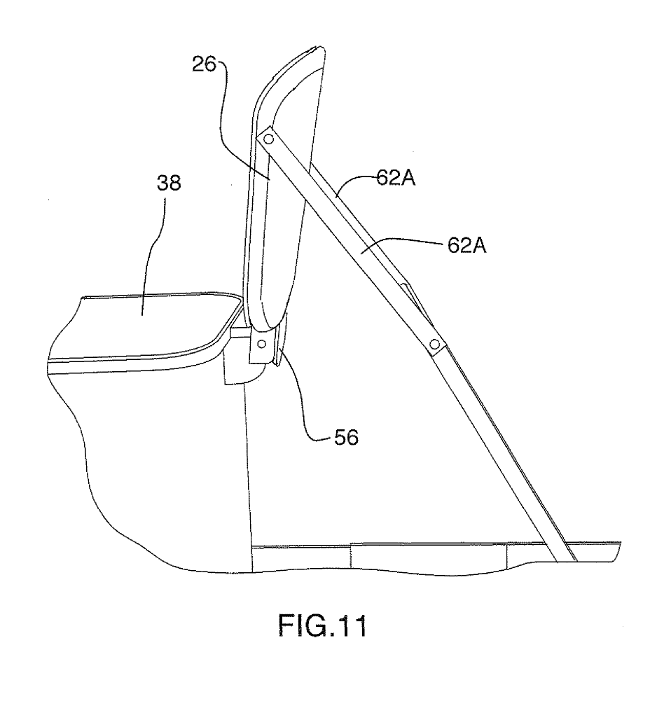

FIG. 12 is a partial view similar to FIG. 10 and showing apparatus according to an alternate embodiment; and

FIG. 13 is a view similar to FIG. 1, with the bin shown in phantom outline.

### DETAILED DESCRIPTION

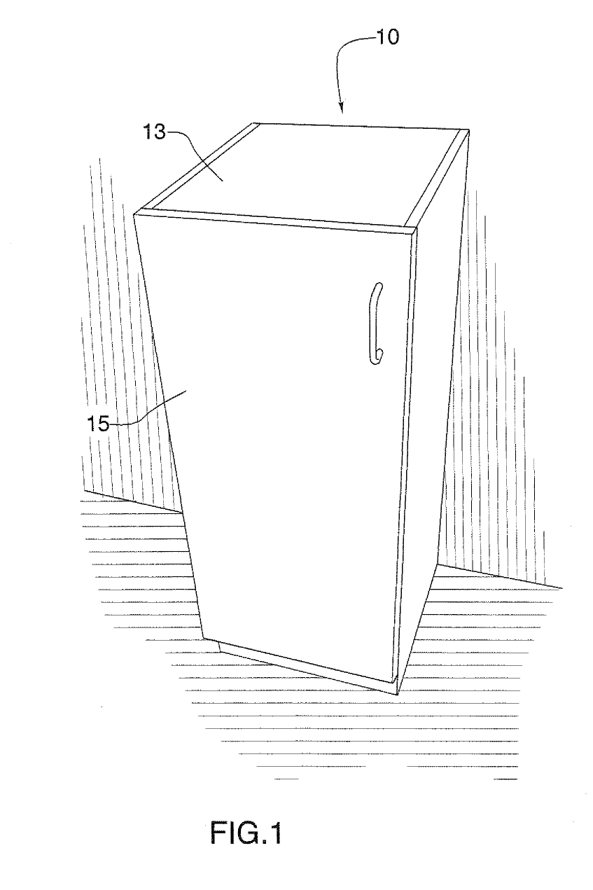

For the purpose of clarity in the description of the preferred embodiment which follows, reference is initially made to FIG. 1 which shows a base cabinet 10. Base cabinet 10 will be understood to form no part of the present invention.

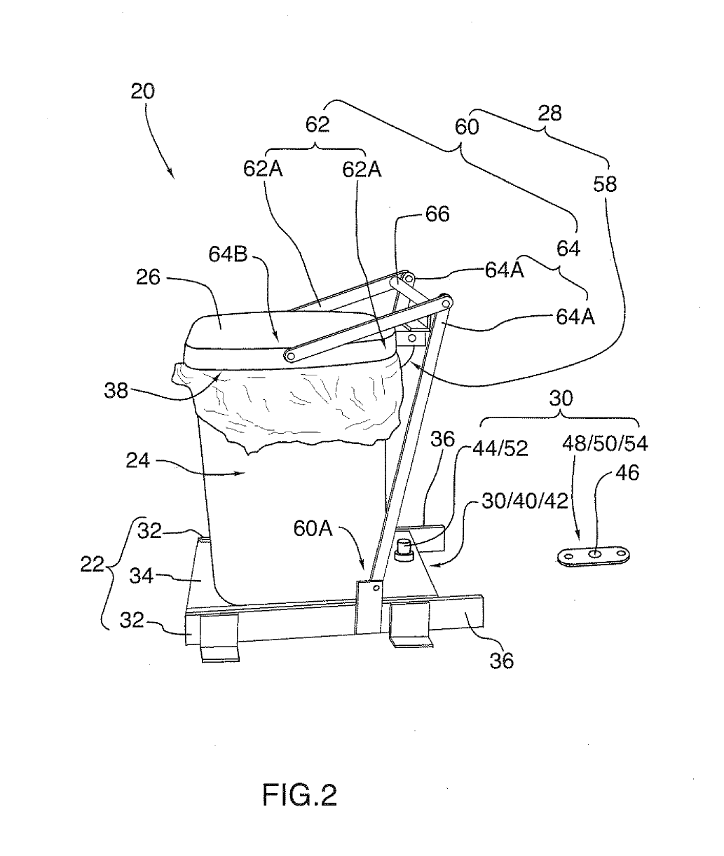

Turning now to FIG. 2, the preferred embodiment of the apparatus 20 of the present invention is herein shown in isolation in FIG. 2 and will be seen to comprise a shuttle assembly 22, a bin 24, a lid 26, a lid-lifting mechanism 28 and an automation system 30.

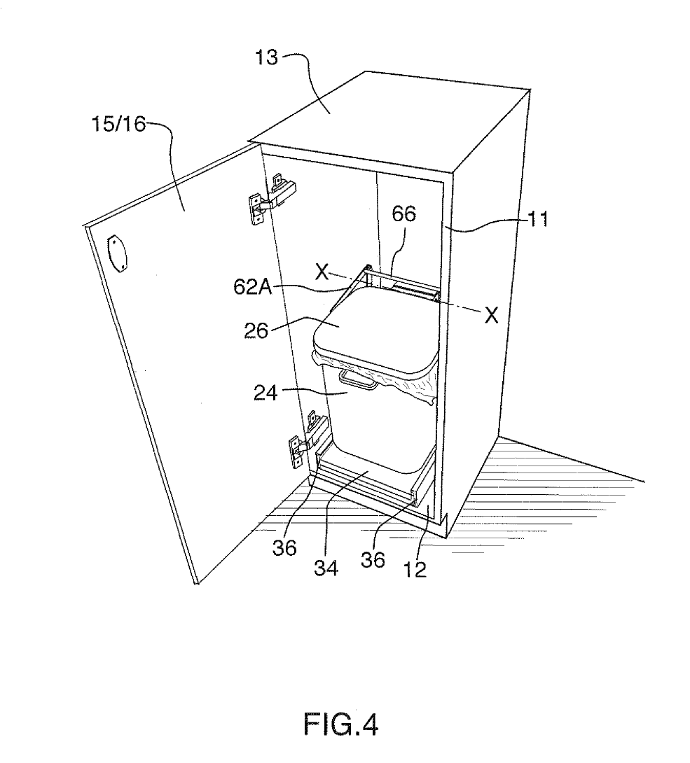

FIG. 4 shows the apparatus of FIG. 2 in use with the apparatus of FIG. 1 and herein it will be seen that the cabinet 10 is of the type having: a planar front face 11, a cabinet bottom 12, a countertop 13; and a door 15 hingedly connected to the front face 11 and defining a closure 16.

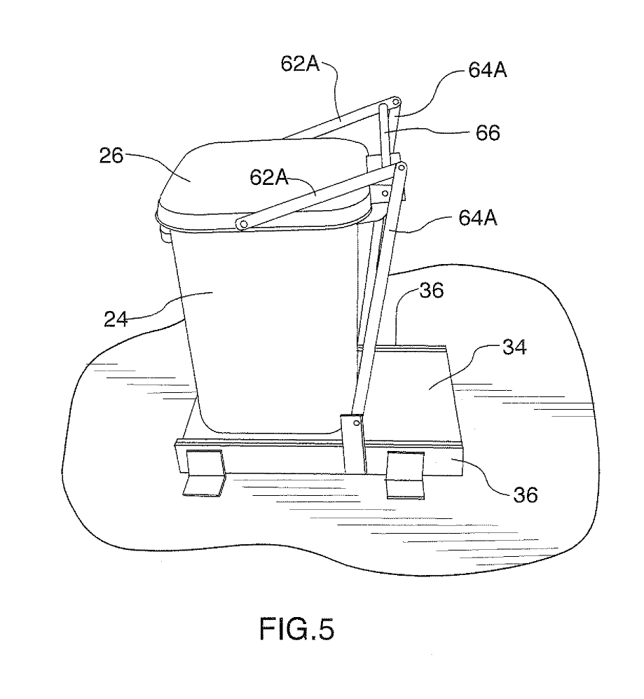

With reference to FIG. 2, this shuttle assembly 22 includes a fixed part 32 and a movable part 34. The fixed part 32 is defined by a pair of tracks 36 that are mounted to the bottom 12 of the cabinet 10 in use. The movable part 34 is defined by a platform 34 that is mounted to the tracks 36 for horizontal sliding movement, as evidenced by the sequence of FIGS. 5, 8, 10.

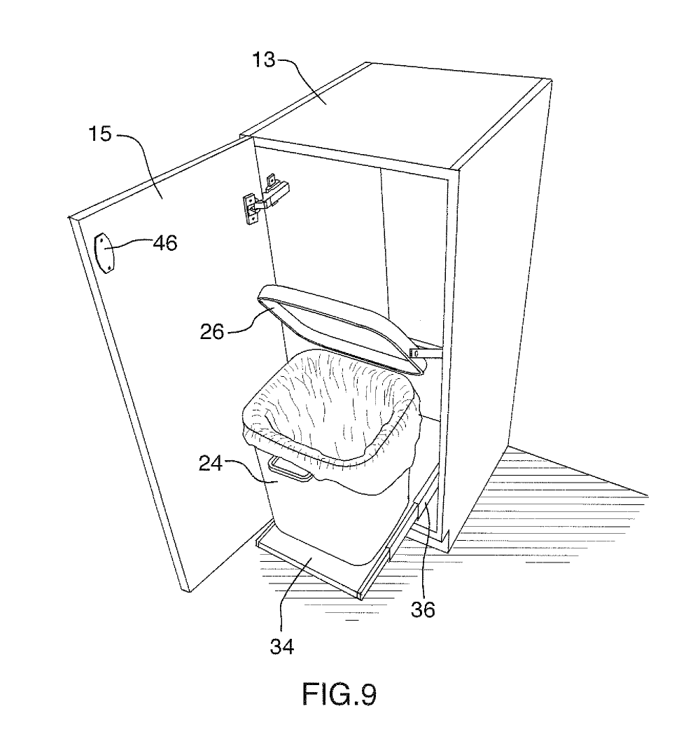

Returning to FIG. 2, this bin 24 has an upper rim 38 and will be seen to be supported by the shuttle assembly 22 for horizontal movement in use, when the door 15 is open, between a storage position inside said cabinet 10, shown in FIG. 4 and an access position outside said cabinet 10, as shown in FIG. 9. The bin 24 will also be understood to have an axis X-X which, when the bin 24 is in the storage position, is parallel to the front face 11 and adjacent that part of the rim 38 that is furthest from the front face 11.

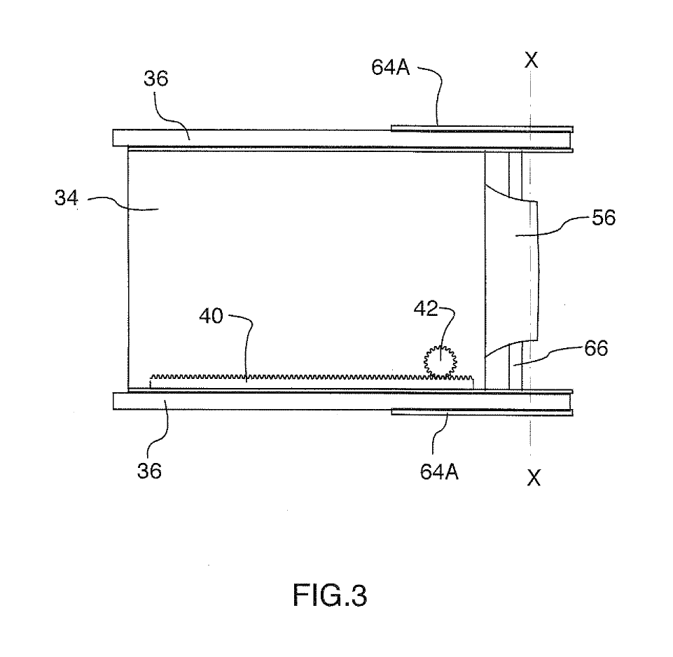

With reference to FIGS. 2 and 3, this automation system 30 includes: a rack 40; a pinion 42; a motor 44; a switch 46; a transmitter 48; a housing 50; and a receiver 52. The rack 40 is fixed to one of the tracks 36. The pinion 42 is in mesh with the rack 40. The motor 44 is connected to drive the pinion 42 and carried by the platform 34. The switch 46 and transmitter 48 are packaged together, along with a battery 54, in the housing 50, which itself is mounted in use on the interior of the door closure, i.e. on the inside of the door 15, all as shown for example in FIG. 4.

The transmitter 48 is adapted to produce wireless signals in response to the switch 46 and is powered by the battery 54. The receiver 52 is adapted to actuate the motor 44 in response to the wireless signals such that the switch 46, if actuated when the bin 24 is in the access position, causes the motor 44 to drive the bin 24 to the storage position and the switch 46, if actuated when the bin 24 is in the storage position, causes the motor 44 to drive the bin 24 to the access position. The motor 44 can be powered by an internal battery, as shown, or via a connection to house current (not shown). Details of the manner by which a switch-transmitter-receiver-motor having the above functionality can be construed is a matter of routine to persons of ordinary skill in the art and as such, further detail is neither provided nor required.

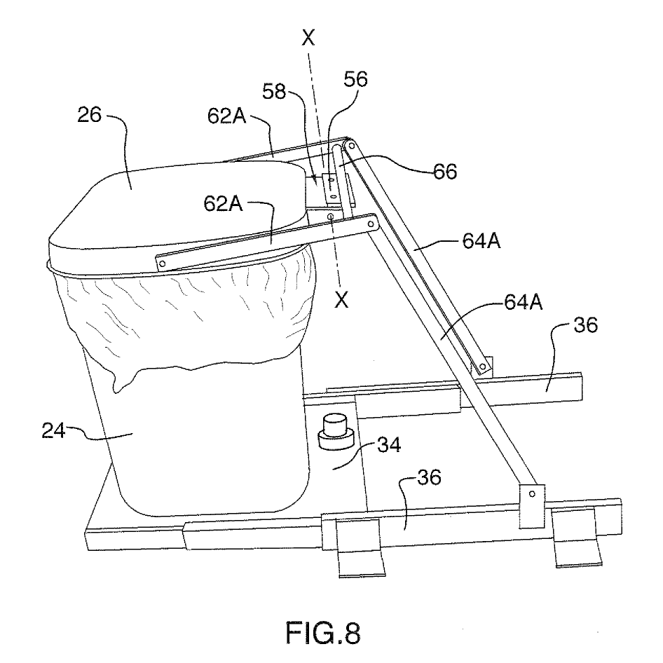

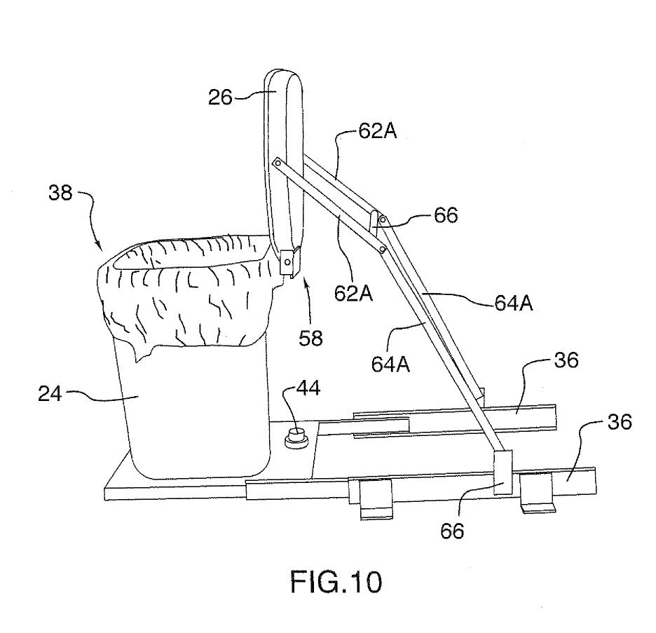

This lid 26 will be seen to have: a closed position associated with the storage position of the bin 24 and whereat the lid 26 occludes the bin 24, as shows in FIGS. 2 and 4; and an open position associated with the access position of the bin 24 and whereat the lid 26 projects upwardly from the axis X-X to permit egress to the bin 24, as shown in FIG. 10. Notably, the lid 26 includes a portion 56 which, when the lid 26 is in the closed position on the bin 24, cantilevers beyond the axis X-X, as shown in FIG. 8 Returning again to FIG. 2, the lid-lifting mechanism 28 comprises:
a hinged connection 58 between the lid 26 and the bin 24, to permit pivotable movement of the lid 26 about the axis X-X; and
a fixed-length, flexible link 60 connected at one end 60A to the fixed part 32 and at the other end 60B to the lid 26

The flexible link 60 includes a pair of link parts 62,64 and an abutment portion 66. The link parts 62,64, which each consist of a pair of arms 62A, 62A and 64A, 64A, spaced apart from one another in the direction of the axis X-X, are pivotably connected to one another, with the free ends of these link parts 62,64 defining the ends 60A, 60B of the flexible link 60. The abutment portion 66 consists of a cross-bar rigidly connecting one of the arm pairs 62A,62A adjacent the junction of the link parts 62,64.

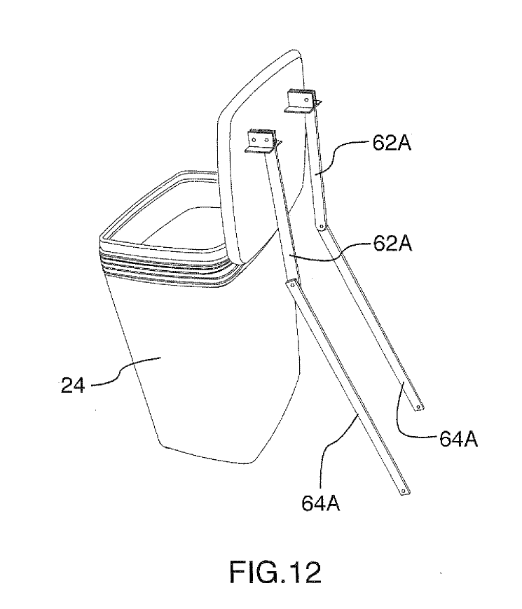

The flexible link 60 is adapted to cause the lid 26 to move between the closed position and the open position as the bin 24 is moved between the storage position and the access position, as shown by the sequence of FIGS. 5, 8 and 10. Notably, in the preferred embodiment, as the bin 24 moves from the storage position to the access position, the abutment portion 66 bears downwardly upon the cantilevered portion 56 of the lid 26 to drive the lid 26 towards the open position, as shown in FIG. 8. This has advantage in that it provides for a smooth operation and a relatively constant load profile borne by the motor 44 in operation. For similar reasons, stop members 66 are provided on the link parts 62,64, as shown in FIG. 10, to limit their range of motion and restrain the lid 26 against movement beyond the open position.

Whereas in the preferred embodiment illustrated, the link is defined by arms disposed on opposite sides of the lid, the link can also, for example, be defined by arms connected to the top of the lid, as shown in FIG. 12. At least in this embodiment, the cross-member can, if desired, be omitted.

Both embodiments maintain many of the advantages associated with the popular undersink wire frame, namely, convenient access and the ability to use cabinet space under the sink. At the same time, they additionally allow the user to access the receptacle without touching the lid, which has advantage in terms of hygiene and cleanliness.

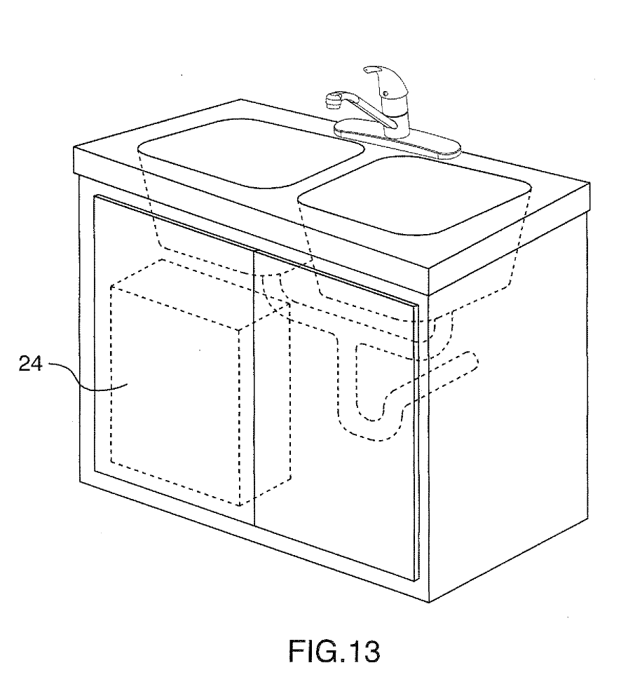

In an advantageous embodiment, as shown in FIG. 13, the dimensions of the bin 24 are such that, with the apparatus operatively mounted behind a cabinet door in a sink cabinet, the bin 24, when in the storage position, substantially fully occupies the space available between the sink/drain and door.

Further variations are possible, including but not limited to use of the apparatus for recycling and/or composting purposes. As well, whereas electrified, automated embodiments are shown, a manual version could be deployed with similar utility. The link could also be defined by a cable and could also be fixed directly to the cabinet. Accordingly, the invention should be understood as limited only by the accompanying claims, purposively construed.

1. Apparatus for use in a base cabinet, the cabinet being of the type having a planar front face in receipt of one or more doors, the one or more doors defining a door closure, the apparatus comprising:
a shuttle assembly mounted in use to the cabinet;
a bin mounted to the shuttle assembly for horizontal movement in use, at least when said one or more doors are open, between a storage position inside said cabinet and an access position outside said cabinet, the bin having an upper rim and an axis, the axis, when the bin is in the storage position, being parallel to the front face and adjacent that part of the rim that is furthest from the front face;
a lid having:
a) a closed position associated with the storage position of the bin and whereat the lid occludes the bin;
b) an open position associated with the access position of the bin and whereat the lid projects upwardly from the axis to permit egress to the bin; and
c) a mechanism adapted to cause the lid to move between the closed position and the open position as the bin is moved between the storage position and the access position.

2. Apparatus according to claim 1, wherein the bin is relatively shallow and the storage position is adjacent the front face to permit use of the apparatus in a sink cabinet.

3. Apparatus according to claim 1, adapted to permit use in a sink cabinet.

4. Apparatus according to claim 3, adapted such that, when the apparatus is in use with a sink cabinet, the bin is in the storage position and the cabinet doors are closed, the bin substantially fully occupies the space (i) between the sink and drain and the front face; and (ii) behind one of the doors.

5. Apparatus according to claim 1, further comprising an automation system including a motor and adapted to drive the bin between the storage and access positions.

6. Apparatus according to claim 5, wherein the automation system comprises: a rack operatively fixedly mounted to one of the shuttle assembly and the bin; and a pinion in mesh with the rack, operatively fixedly mounted to the other of the track and the bin and coupled to the motor.

7. Apparatus according to claim 5, wherein the automation system comprises: a switch which, if actuated when the bin is in the access position, drives the bin to the storage position.

8. Apparatus according to claim 7, wherein the switch, if actuated when the bin is in the storage position, drives the bin to the access position.

9. Apparatus according to claim 1, wherein the shuttle assembly includes:
a fixed part that is mounted in use to the box; and
a movable part that supports the bin and is mounted to the fixed part for sliding movement.

10. Apparatus according to claim 9, wherein the fixed part comprises a pair of tracks and the movable part comprises a platform.

11. Apparatus according to claim 1, wherein the mechanism comprises a hinged connection between the lid and the bin, to permit pivotable movement of the lid about the axis.

12. Apparatus according to claim 11, wherein the mechanism further comprises a fixed-length, flexible link connected at one end to the fixed part and at the other end to the lid.

13. Apparatus according to claim 12, wherein the link includes a pair of link parts pivotably connected to one another, the free ends of these link parts defining the ends of the link.

14. Apparatus according to claim 13, wherein the lid includes a portion which, when the lid is in the closed position on the bin, cantilevers beyond the axis; and the link includes a portion, adjacent the junction of the link parts, that, as the bin moves from the storage position to the access position, bears downwardly upon the cantilevered portion of the lid to drive the lid towards the open position.

15. Apparatus according to claim 14, wherein the link parts each consist of a pair of arms, spaced apart from one another in the direction of the axis; and the portion consists of a cross-bar rigidly connecting one of the arm pairs.

16. Apparatus according to claim 13, adapted to restrain the lid against movement beyond the open position.

17. Apparatus according to claim 7, further comprising:
a transmitter, the transmitter being: packaged with the switch; adapted to be mounted on the interior of said door closure; and adapted to produce wireless signals in response to the switch;
a receiver adapted to actuate the motor in response to the wireless signals.

18. Apparatus according to claim 17, wherein the transmitter is contained in a housing having a battery receiver and is adapted to be powered by battery power emanating from said receiver in use.
